(19) United States
(12) Patent Application Publication
(10) Pub. No.: US 2024/0309153 A1
(43) Pub. Date: Sep. 19, 2024

(54) IONENE STAR POLYMERS

(71) Applicant: The Board of Trustees of The University of Alabama, Tuscaloosa, AL (US)

(72) Inventors: Jason Edward Bara, Tuscaloosa, AL (US); Kathryn Elizabeth O'Harra, Tuscaloosa, AL (US)

(21) Appl. No.: 18/413,534

(22) Filed: Jan. 16, 2024

Related U.S. Application Data
(60) Provisional application No. 63/452,255, filed on Mar. 15, 2023.

(51) Int. Cl. C08G 73/06

(52) U.S. Cl. CPC C08G 73/0616

(57) ABSTRACT

The present disclosure provides star polymers that have ionic moieties in their backbones, more specifically ionene star polymers of Formula I and Formula II.

### CROSS-REFERENCE TO RELATED APPLICATIONS

This application claims the benefit of priority to U.S. Provisional Patent Application No. 63/452,255 filed Mar. 15, 2023, the disclosure of which is incorporated herein by reference in its entirety.

### STATEMENT REGARDING FEDERALLY SPONSORED RESEARCH OR DEVELOPMENT

This invention was made with government support under Grant No. 1605411 awarded by the National Science Foundation. The Government has certain rights in the invention.

### TECHNICAL FIELD

This disclosure relates to polymers, and more particularly to ionene star polymers and uses thereof.

### BACKGROUND

Star polymers represent a broad class of branched macromolecular architectures with linear arms radiating from a central branching point, typically referred to as the core. These macromolecules can be further classified according to monomer composition, distribution of the arm polymer, and chemical structure or molecular nature of the core. They represent one of the simplest deviations from one-dimensional linear polymers and have, therefore, been the subject of immense interest for chemists and material scientists seeking higher-order architectures with unique properties due to their spatially defined yet compact three-dimensional structure. A diverse range of star polymer structures have previously been realized through controlled polymerization techniques, including miktoarm, block copolymer, network-core, and end-functionalized star polymers. Star polymers have found use as interfacial stabilizing agents, for drug delivery and encapsulation, imaging (for example, MRI), nanoreactors and catalysis, as viscosity modified, as gelling agents in cosmetics, and as adhesives, sealants, or coatings.

Complex polymer architectures with controlled dimensions and functionality must be synthetically designed to produce the core and protruding arms. Many star polymers possess neutral cores and/or arms, but some may contain ionic pendant groups along the arms. Further, star polymers typically rely upon controlled anionic/cationic or living chain polymerization techniques rather than step-growth or condensation polymerizations.

Ionenes are a type of ionic polymer where the ionic moieties are embedded along the backbone rather than pendant from the main chain, such as found in polyelectrolytes. While ionenes have been known for almost a century, no ionenes have been previously described with a star polymer architecture.

### SUMMARY

The present disclosure provides star polymers containing ionic moieties embedded in the backbone of the structures, i.e., ionene star polymers. These materials have a broadened range of properties compared to either non-ionic star polymers or linear ionene polymers.

In one aspect, a star polymer is provided of Formula I:

A¹—[L¹—A²—(A³)ₘ—A⁴]ₙ (I)

wherein all variables are as defined further herein.

In another aspect, a star polymer is provided of Formula II:

[A⁴—(A³)ₘ—A²—L¹]ₙ—A^{1′}—L³—A^{1′}—[L¹—A²—(A³)ₘ—A⁴]ₙ (II)

wherein all variables are as defined further herein.

Methods for the manufacture of star polymers described herein are also provided.

The details of one or more aspects of the disclosure are set forth in the accompanying drawings and the description below. Other features, objects, and advantages of the disclosure will be apparent from the description, the drawings, and the claims.

### DESCRIPTION OF DRAWINGS

FIG. 1 is a scheme depicting the preparation of a representative A-B monomer used in the preparation of the arms of the star polymers of the present disclosure.

FIGS. 2A, 2B, and 2C depict representative core structures used in the preparation of the star polymers of the present disclosure.

FIG. 3 is a scheme showing the synthesis of representative star polymers of the present disclosure.

FIGS. 4A and 4B provide the structure of a representative star polymer of the present disclosure and a photograph of the same as prepared by the described methods.

FIGS. 5A, 5B, and 5C provide the structure of a representative star polymer of the present disclosure and photographs of the same as prepared by the described methods.

FIGS. 6A and 6B provide data showing the thermal stability of representative star polymers of the present disclosure.

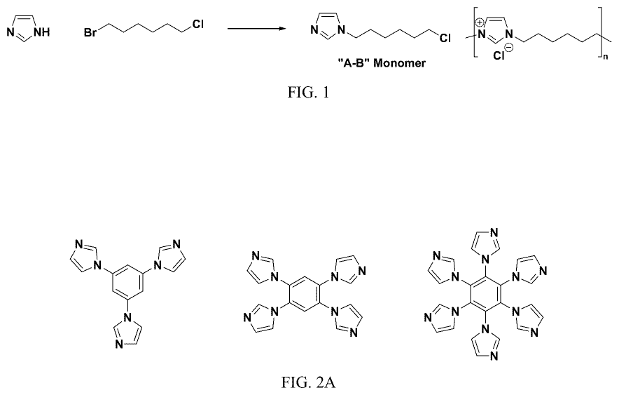

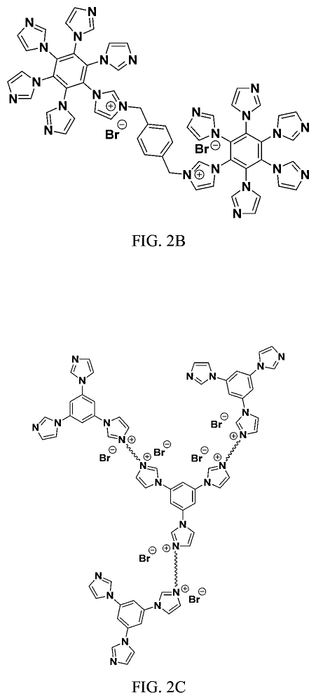

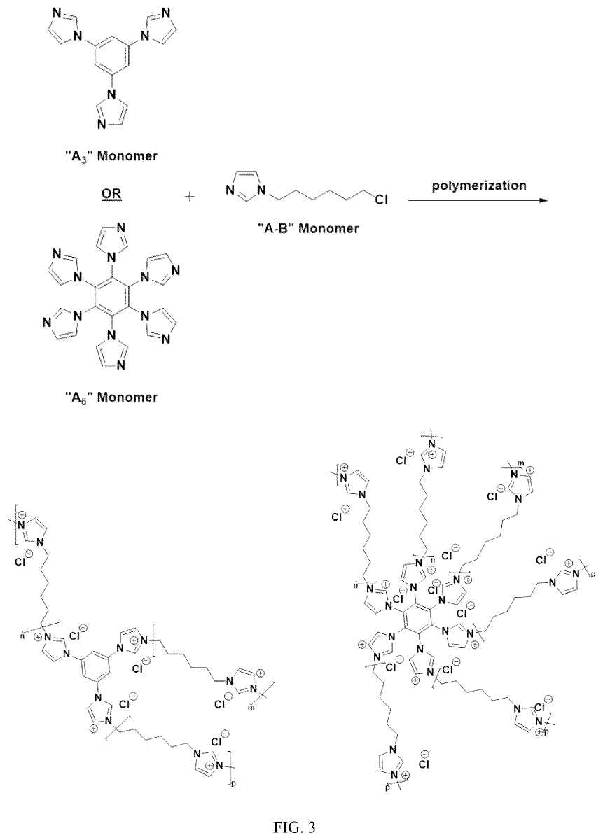

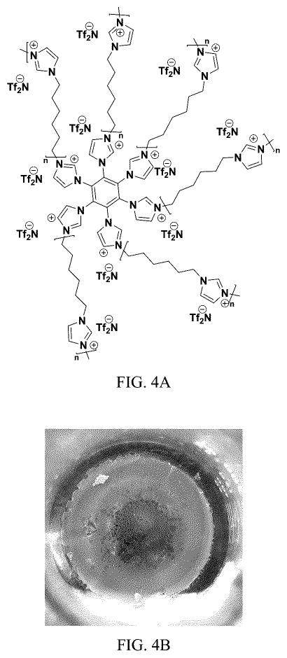

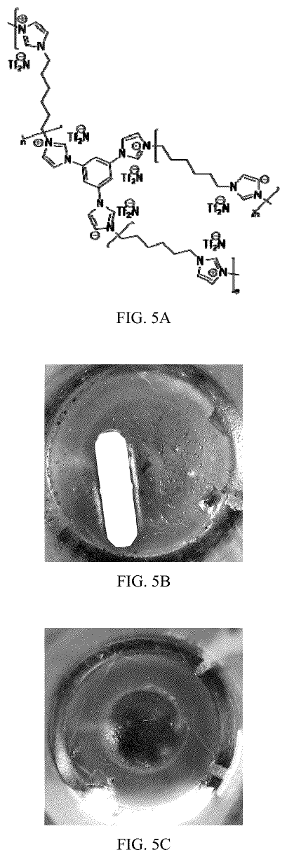

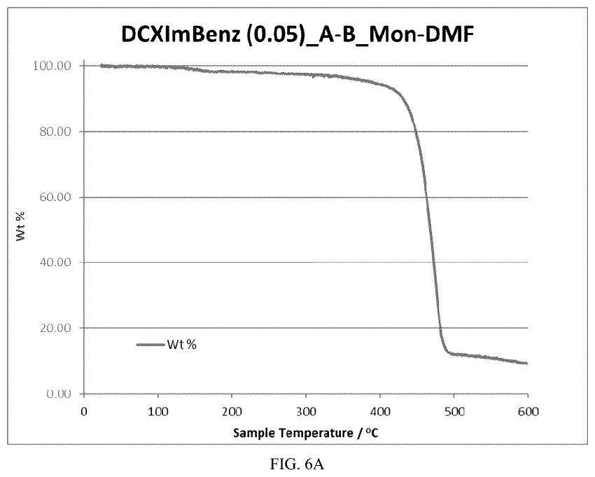

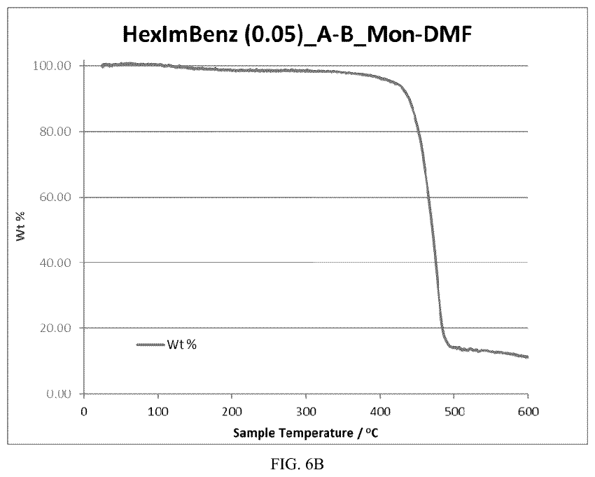

Like reference symbols in the various drawings indicate like elements.

### DETAILED DESCRIPTION

The following description of the disclosure is provided as an enabling teaching of the disclosure in its best, currently known aspects. Many modifications and other aspects disclosed herein will come to mind to one skilled in the art to which the disclosed compositions and methods pertain, benefiting from the teachings presented in the descriptions herein and the associated drawings. Therefore, it is understood that the disclosures are not limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As apparent to those of skill in the art upon reading this disclosure, each of the individual aspects described and illustrated herein has discrete components and features that may be readily separated from or combined with the features of any of the other several aspects without departing from the scope or spirit of the present disclosure.

Any recited method can be carried out in the order of events recited or any other order that is logically possible. Unless otherwise expressly stated, it is in no way intended that any method or aspect set forth herein be construed as requiring that its steps be performed in a specific order. Accordingly, where a method claim does not explicitly state in the claims or descriptions that the steps are to be limited to a particular order, it is in no way intended that an order be inferred in any respect. This holds for any possible non-express basis for interpretation, including logic concerning arrangement of steps or operational flow, meaning derived from grammatical organization or punctuation, or the number or type of aspects described in the specification.

All publications mentioned herein are incorporated by reference to disclose and describe the methods or materials in connection with which the publications are cited. The publications discussed herein are provided solely for their disclosure before the filing date of the present application. Nothing herein is to be construed as an admission that the present invention is not entitled to antedate such publication by prior invention. Further, the dates of publication provided herein can be different from the actual publication dates, which can require independent confirmation.

It is also to be understood that the terminology herein describes particular aspects only and is not intended to be limiting. Unless defined otherwise, all technical and scientific terms herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Before describing the various aspects of the present disclosure, the following definitions are provided and should be used unless otherwise indicated. Additional terms may be defined elsewhere in the present disclosure.

### Definitions

As used herein, “comprising” is interpreted as specifying the presence of the stated features, integers, steps, or components but does not preclude the presence or addition of one or more features, integers, steps, components, or groups thereof. Moreover, each of the terms “by,” “comprising,” “comprises,” “comprised of,” “including.” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, “consisting essentially of” is intended to include examples encompassed by the term “consisting of.”

As used in the specification and the appended claims, the singular forms “a,” “an,” and “the” include plural referents unless the context dictates otherwise. Thus, for example, reference to “a polymer,” “a monomer,” or “a solvent” includes, but is not limited to, two or more such polymers, monomers, or solvents, and the like.

Ratios, concentrations, amounts, and other numerical data can be expressed herein in a range format. Further, the endpoints of each of the ranges are significant both in relation to the other endpoint and independently of the other endpoint. There are many values disclosed herein, and each value is also disclosed as “about” that particular value in addition to the value itself. For example, if the value “10” is disclosed, then “about 10” is also disclosed. Ranges can be expressed herein as from “about” one particular value and to “about” another particular value. Similarly, when values are expressed as approximations, using the antecedent “about,” the particular value forms a further aspect. For example, if the value “about 10” is disclosed, then “10” is also disclosed.

When a range is expressed, a further aspect includes from the one particular value and to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., “about x, y, z, or less” and should be interpreted to include the specific ranges of ‘about x,’ “about y,” and ‘about z’ as well as the ranges of ‘less than x,’ ‘less than y.’ and ‘less than z.’ Likewise, the phrase ‘about x, y, z, or greater’ should be interpreted to include the specific ranges of ‘about x,’ ‘about y,’ and ‘about z’ as well as the ranges of ‘greater than x,’ greater than y,′ and ‘greater than z.’ In addition, the phrase “about ‘x’ to ‘y’,” where ‘x’ and ‘y’ are numerical values, includes “about ‘x’ to about ‘y’.”

Such a range format is used for convenience and brevity and, thus, should be interpreted flexibly to include not only the numerical values explicitly recited as the limits of the range but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5% but also include individual values (e.g., about 1%, about 2%, about 3%, and about 4%) and the sub-ranges (e.g., about 0.5% to about 1.1%: about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, amounts, sizes, formulations, parameters, and other quantities and characteristics are not and need not be exact but may be approximate, larger or smaller, as desired, reflecting tolerances, conversion factors, rounding, measurement error, and the like, and other factors known to those of skill in the art such that equivalent results or effects are obtained. In some circumstances, the value that provides equivalent results or effects cannot be reasonably determined. In such cases, as used herein, “about” and “at or about” mean the nominal value indicated±10% variation unless otherwise indicated or inferred. In general, an amount, size, formulation, parameter, or other quantity or characteristic is “about,” “approximate,” or “at or about,” whether or not expressly stated to be such. Where “about,” “approximate,” or “at or about” is used before a quantitative value, the parameter also includes the specific quantitative value itself unless expressly stated otherwise.

As used herein, “optional” or “optionally” means that the subsequently described event or circumstance can or cannot occur. The description includes instances where said event or circumstance occurs and those where it does not.

Compounds are described using standard nomenclature. Unless defined otherwise, all technical and scientific terms used herein have the same meaning as is commonly understood by one of skill in the art to which this invention belongs.

The compounds described herein include enantiomers, mixtures of enantiomers, diastereomers, tautomers, racemates, and other isomers, such as rotamers, as if each is specifically described unless otherwise indicated or otherwise excluded by context. It is to be understood that the compounds provided herein may contain chiral centers. Such chiral centers may be of either the (R-) or (S-) configuration. The compounds provided herein may either be enantiomerically pure or diastereomeric or enantiomeric mixtures. Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture.

A dash (“-”) that is not between two letters or symbols is used to indicate a point of attachment for a substituent. For example, —(C═O)NH₂ is attached through the carbon of the keto (C═O) group.

The term “substituted,” as used herein, means that any one or more hydrogens on the designated atom or group are replaced with a moiety selected from the indicated group, provided that the designated atom's normal valence is not exceeded and the resulting compound is stable. For example, when the substituent is oxo (i.e., ═O) then two hydrogens on the atom are replaced. For example, a pyridyl group substituted by oxo is a pyridine. Combinations of substituents and/or variables are permissible only if such combinations result in stable compounds or useful synthetic intermediates.

Any suitable group may be present on a “substituted” or “optionally substituted” position that forms a stable molecule and meets the desired purpose of the invention and includes, but is not limited to: alkyl, haloalkyl, alkoxy, alkenyl, alkynyl, aryl, heteroaryl, cycloalkyl, heterocycle, aldehyde, amino, carboxylic acid, ester, ether, halo, hydroxy, keto, nitro, cyano, azido, oxo, silyl, sulfo-oxo, sulfonyl, sulfone, sulfoxide, sulfonylamino, or thiol.

The terms for various functional groups as used herein are not intended to be limited to monovalent radicals and may include polyvalent radical groups as appropriate, such as divalent, trivalent, tetravalent, pentavalent, and hexavalent groups, and the like, based on the position and location of such groups in the compounds described herein as would be readily understood by the skilled person.

“Alkyl” is a straight chain or branched saturated aliphatic hydrocarbon group. In certain aspects, the alkyl is C₁-C₂, C₁-C₃, or C₁-C₆ (i.e., the alkyl chain can be 1, 2, 3, 4, 5, or 6 carbons in length). The specified ranges, as used herein, indicate an alkyl group with a length of each member of the range described as an independent species. For example, C₁-C₆alkyl, as used herein, indicates an alkyl group having from 1, 2, 3, 4, 5, or 6 carbon atoms and is intended to mean that each of these is described as an independent species, and C₁-C₄alkyl, as used herein, indicates an alkyl group having from 1, 2, 3, or 4 carbon atoms and is intended to mean that each of these is described as an independent species. When C₀-Cₙalkyl is used herein in conjunction with another group, for example (C₃-C_{7cycloalkyl})C₀-C₄alkyl, or —C₀-C₄(C₃-C_{7cycloalkyl}), the indicated group, in this case cycloalkyl, is either directly bound by a single covalent bond (C₆alkyl), or attached by an alkyl chain, in this case 1, 2, 3, or 4 carbon atoms. Alkyls can also be attached via other groups, such as heteroatoms, as in —O—C₀-C₄alkyl(C₃-C_{7cycloalkyl}). Examples of alkyl include, but are not limited to, methyl, ethyl, n-propyl, isopropyl, n-butyl, isobutyl, sec-butyl, t-butyl, n-pentyl, isopentyl, tert-pentyl, neopentyl, n-hexyl, 2-methylpentane, 3-methylpentane, 2,2-dimethylbutane, and 2,3-dimethylbutane. In one aspect, the alkyl group is optionally substituted as described herein.

“Cycloalkyl” is a saturated mono—or multicyclic hydrocarbon ring system. When composed of two or more rings, the rings may be joined together in a fused or bridged fashion. Non-limiting examples of typical cycloalkyl groups include cyclopropyl, cyclobutyl, cyclopentyl, cyclohexyl, and cycloheptyl. In one aspect, the cycloalkyl group is optionally substituted as described herein.

“Alkenyl” is a straight or branched chain aliphatic hydrocarbon group having one or more carbon-carbon double bonds, each of which is independently either cis or trans, that may occur at a stable point along the chain. Non-limiting examples include C₂-C₄alkenyl and C₂-C₆alkenyl (i.e., having 2, 3, 4, 5, or 6 carbons). The specified ranges as used herein indicate an alkenyl group having each member of the range described as an independent species, as described above for the alkyl moiety. Examples of alkenyl include, but are not limited to, ethenyl and propenyl. In one aspect, the alkenyl group is optionally substituted as described herein.

“Alkynyl” is a straight or branched chain aliphatic hydrocarbon group having one or more carbon-carbon triple bonds that may occur at any stable point along the chain, for example, C₂-C₄alkynyl or C₂-C₆alkynyl (i.e., having 2, 3, 4, 5, or 6 carbons). The specified ranges as used herein indicate an alkynyl group, with each member of the range described as an independent species, as described above for the alkyl moiety. Examples of alkynyl include, but are not limited to, ethynyl, propynyl, 1-butynyl, 2-butynyl, 3-butynyl, 1-pentynyl, 2-pentynyl, 3-pentynyl, 4-pentynyl, 1-hexynyl, 2-hexynyl, 3-hexynyl, 4-hexynyl, and 5-hexynyl. In one aspect, the alkynyl group is optionally substituted as described herein.

“Alkoxy” is an alkyl group, as defined above, covalently bound through an oxygen bridge (—O—). Examples of alkoxy include, but are not limited to, methoxy, ethoxy, n-propoxy, isopropoxy, n-butoxy, 2-butoxy, tert-butoxy, n-pentoxy, 2-pentoxy, 3-pentoxy, isopentoxy, neopentoxy, n-hexoxy, 2-hexoxy, 3-hexoxy, and 3-methylpentoxy. Similarly, an “alkylthio” or “thioalkyl” group is an alkyl group as defined above, with the indicated number of carbon atoms covalently bound through a sulfur bridge (—S—). In one aspect, the alkoxy group is optionally substituted as described herein.

“Alkanoyl” is an alkyl group, as defined above, covalently bound through a carbonyl (C═O) bridge. The carbonyl carbon is included in the number of carbons. For example. C₂₀alkanoyl is a CH₃(C═O)-group. In one aspect, the alkanoyl group is optionally substituted as described herein.

“Halo” or “halogen” indicates, independently, any of fluoro, chloro, bromo, or iodo.

“Aryl” indicates an aromatic group containing only carbon in the aromatic ring or rings. In one aspect, the aryl group contains 1 to 3 separate or fused rings and is 6 to 14 or 18 ring atoms, without heteroatoms as ring members. When indicated, such aryl groups may be further substituted with carbon or non-carbon atoms or groups. Such substitution may include fusion to a 4— to 7—or 5— to 7-membered saturated or partially unsaturated cyclic group that optionally contains 1, 2, or 3 heteroatoms independently selected from N, O, B, P. Si and S to form, for example, a 3,4-methylenedioxyphenyl group. Aryl groups include, for example, phenyl and naphthyl, including 1-naphthyl and 2-naphthyl. In one aspect, aryl groups are pendant. An example of a pendant ring is a phenyl group substituted with a phenyl group. In one aspect, the aryl group is optionally substituted as described herein.

The term “heterocycle” refers to saturated and partially saturated heteroatom-containing ring radicals, where the heteroatoms may be selected from N, O, and S. The term heterocycle includes monocyclic 3-12 members rings, as well as bicyclic 5-16 membered ring systems (which can include fused, bridged, or spiro bicyclic ring systems). It does not include rings containing —O—O—,—O—S—, and —S—S—portions. Examples of saturated heterocycle groups include saturated 4— to 7-membered monocyclic groups containing 1 to 4 nitrogen atoms [e.g., pyrrolidinyl, imidazolidinyl, piperidinyl, pyrrolinyl, azetidinyl, piperazinyl, and pyrazolidinyl]: saturated 4— to 6-membered monocyclic groups containing 1 to 2 oxygen atoms and 1 to 3 nitrogen atoms [e.g., morpholiny]; and saturated 3— to 6—membered heteromonocyclic groups containing 1 to 2 sulfur atoms and 1 to 3 nitrogen atoms [e.g., thiazolidiny]. Examples of partially saturated heterocycle radicals include, but are not limited to, dihydrothienyl, dihydropyranyl, dihydrofuryl, and dihydrothiazolyl. Examples of partially saturated and saturated heterocycle groups include, but are not limited to, pyrrolidinyl, imidazolidinyl, piperidinyl, pyrrolinyl, pyrazolidinyl, piperazinyl, morpholinyl, thiazolidinyl, tetrahydropyranyl, dihydrothienyl, 2,3-dihydro-benzo[1,4]dioxanyl, indolinyl, isoindolinyl, dihydrobenzothienyl, dihydrobenzofuryl, isochromanyl, chromanyl, 1,2-dihydroquinolyl, 1,2,3,4-tetrahydro-isoquinolyl, 1,2,3,4-tetrahydro-quinolyl, 2,3,4,4a,9,9a-hexahydro-1H-3-aza-fluorenyl, 5,6,7-trihydro-1,2,4-triazolo[3,4-a]isoquinolyl, 3,4-dihydro-2H-benzo[1,4]oxazinyl, benzo[1,4]dioxanyl, 2,3,-dihydro-1H-benzo[d]isothazol-6-yl, dihydropyranyl, dihydrofuryl, and dihydrothiazolyl. Bicyclic heterocycle includes groups wherein the heterocyclic radical is fused with an aryl radical wherein the point of attachment is the heterocycle ring. Bicyclic heterocycle also includes heterocyclic radicals that are fused with a carbocyclic radical. Representative examples include, but are not limited to, partially unsaturated condensed heterocyclic groups containing 1 to 5 nitrogen atoms, for example, indoline and isoindoline, partially unsaturated condensed heterocyclic groups containing 1 to 2 oxygen atoms and 1 to 3 nitrogen atoms, partially unsaturated condensed heterocyclic groups containing 1 to 2 sulfur atoms and 1 to 3 nitrogen atoms, and saturated condensed heterocyclic groups containing 1 to 2 oxygen or sulfur atoms.

“Heteroaryl” refers to a stable monocyclic, bicyclic, or multicyclic aromatic ring that contains from 1 to 4, or in some aspects 1, 2, or 3 heteroatoms selected from N, O. S. B. and P (and typically selected from N, O, and S) with remaining ring atoms being carbon, or a stable bicyclic or tricyclic system containing at least one 5, 6, or 7 membered aromatic ring which contains from 1 to 4, or in some aspects from 1 to 3 or from 1 to 2, heteroatoms selected from N. O. S. B, or P, with remaining ring atoms being carbon. In one aspect, the only heteroatom is nitrogen. In one aspect, the only heteroatom is oxygen. In one aspect, the only heteroatom is sulfur. Monocyclic heteroaryl groups typically have from 5 to 6 ring atoms. In some aspects, bicyclic heteroaryl groups are 8—to 10-membered heteroaryl groups, that is groups containing 8 or 10 ring atoms in which one 5-, 6-, or 7-membered aromatic ring which contains from 1 to 4 heteroatoms selected from N. O. S. B, or P is fused to a second aromatic or non-aromatic ring, wherein the point of attachment is an aromatic ring. When the total number of S and O atoms in the heteroaryl ring exceeds 1, these heteroatoms are not adjacent to one another within the ring. In one aspect, the total number of S and O atoms in the heteroaryl ring is not more than 2. In another aspect, the total number of S and O atoms in the heteroaryl ring is not more than 1. Examples of heteroaryl groups include, but are not limited to, pyridinyl, imidazolyl, imidazopyridinyl, pyrimidinyl, pyrazolyl, triazolyl, pyrazinyl, furyl, thienyl, isoxazolyl, thiazolyl, oxadiazolyl, oxazolyl, isothiazolyl, pyrrolyl, quinolinyl, isoquinolinyl, tetrahydroisoquinolinyl, indolyl, benzimidazolyl, benzofuranyl, cinnolinyl, indazolyl, indolizinyl, phthalazinyl, pyridaziny], triazinyl, isoindolyl, pteridinyl, purinyl, triazolyl, thiadiazolyl, furazany], benzofurazany], benzothiophenyl, benzothiazolyl, benzoxazolyl, quinazolinyl, quinoxalinyl, naphthyridinyl, and furopyridinyl.

As used herein, substantially pure means sufficiently homogeneous to appear free of readily detectable impurities as determined by standard methods of analysis, such as thin layer chromatography (TLC), nuclear magnetic resonance (NMR), gel electrophoresis, high-performance liquid chromatography (HPLC) and mass spectrometry (MS), gas-chromatography mass spectrometry (GC-MS), and similar, used by those of skill in the art to assess such purity, or sufficiently pure such that further purification would not detectably alter the physical and chemical properties of the substance. Both traditional and modern methods for purification of the compounds to produce substantially chemically pure compounds are known to those skilled in the art. A substantially chemically pure compound may, however, be a mixture of stereoisomers.

### Compounds

In one aspect, the present disclosure provides star polymers containing ionic moieties embedded in the backbone of the structures. These materials have a broadened range of properties compared to either non-ionic star polymers or linear ionene polymers.

In one aspect, a star polymer is provided of Formula I:

A¹—[L¹—A²—(A³)ₘ—A⁴]ₙ (I)

wherein:

A¹ is 6—to 10-membered monocyclic or bicyclic aryl optionally substituted with one or more groups selected from R^{x}:

n is an integer selected from 3, 4, 5, or 6 as allowed by valency:

L¹ is independently selected at each occurrence from a bond and —A⁵—A⁶—:

A⁵ is independently selected at each occurrence from the group consisting of a bond, —NH—,—O—,—C(═O)—,—NHC(═O)—,—C(═O)NH—,—OC(═O)—, and —C(═O)O—:

A⁶ is independently selected at each occurrence from the group consisting of a bond and 6—to 10-membered monocyclic or bicyclic aryl optionally substituted with one or more groups selected from RN:

A² is independently at each occurrence

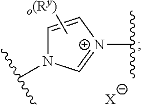

A³ is independently at each occurrence —L²—A⁷—;

m is independently selected at each occurrence from an integer greater than 3;

L² is independently selected at each occurrence from C₁-C₁₂ alkyl, poly(ethylene glycol), poly(propylene glycol), poly(lactic acid), poly(glycolic acid), and poly(lactic acid-co-glycolic acid);

A⁷ is independently selected at each occurrence from

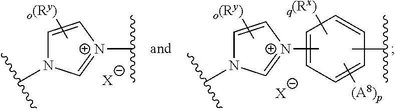

o is independently at each occurrence an integer selected from 0, 1, 2, and 3;

p is independently at each occurrence an integer selected from 1, 2, 3, and 4;

q is independently at each occurrence an integer selected from 0, 1, 2, or 3;

wherein p+q is equal to or less than 4;

A⁸ is independently at each occurrence (A³)ₘ—A⁴;

A⁴ is independently at each occurrence —L²—A⁹;

A⁹ is independently selected at each occurrence from R^{w},

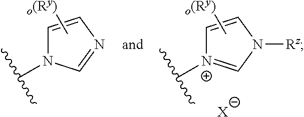

X is independently at each occurrence an anion:

R^{w} is independently selected at each occurrence from alkyl, haloalkyl, alkoxy, alkenyl, alkynyl, aryl, heteroaryl, cycloalkyl, heterocycle, aldehyde, amino, carboxylic acid, ester, ether, halo, hydroxy, keto, nitro, cyano, azido, oxo, silyl, sulfo-oxo, sulfonyl, sulfone, sulfoxide, sulfonylamino, and thiol:

R^{x} and R^{y} independently selected at each occurrence from hydrogen, halo, cyano, nitro, thiol, hydroxy, amino, azido, C₁-C₆ alkyl, C₁-C₆ haloalkyl, and C₁-C₆ alkoxy:

R^{z} is independently selected at each occurrence from hydrogen, C₁-C₆ alkyl, C₂-C₆ alkenyl, C₂-C₆ alkynyl, (C₃-C₆ cycloalkyl)(C₀-C₃ alkyl)-, (3— to 8-membered monocyclic or bicyclic heterocycle)-(C₀-C₃ alkyl)-, (6—to 10-membered monocyclic or bicyclic aryl)-(C₀-C₃ alkyl)-, and (5— to 10-membered monocyclic or bicyclic heteroaryl)-(C₀-C₃ alkyl)-, R^{a}O—(C₁-C₃ alkyl)-, R^{a}S—(C₁-C₃ alkyl)-, (R^{a}R^{b}N)—(C₁-C₃ alkyl)-, R^{a}O—C(O)-(C₀-C₃ alkyl)—, (R^{a}R^{b}N)—C(O)-(C₀-C₃ alkyl)—, R^{c}C(O)—O—(C₁-C₃ alkyl)—, R^{c}C(O)—(R^{a}N)—(C₁-C₃ alkyl)—, RCS(O)₂—O—(C₁-C₃ alkyl)—, RCS(O)₂—(R^{a}N)—(C₁-C₃ alkyl)—, R^{c}C(O)—(C₀-C₆ alkyl)—, and RCS(O)₂—(C₀-C₃ alkyl)—, each of which may be optionally substituted with one or more Y groups as allowed by valency:

R^{a} and R^{b} are independently selected at each occurrence from hydrogen, C₁-C₆alkyl, C₁-C₆haloalkyl, C₂-C₆alkenyl, C₂-C₆alkynyl, (C₃-C_{7cycloalkyl})-(C₀-C₃ alkyl)—, (4— to 6—membered heterocycle)-(C₀-C₃ alkyl)—, (5— to 10-membered monocyclic or bicyclic aryl)-(C₀-C₃ alkyl)—, (5— to 10-membered monocyclic or bicyclic heteroaryl)-(C₀-C₃ alkyl)—, each of which may be optionally substituted with one or more Y groups as allowed by valency:

R^{c} is independently selected at each occurrence from hydrogen, halo, C₁-C₆alkyl, C₁-C⁶haloalkyl, C₂-C₆alkenyl, C₂-C₆alkynyl, (C₃-C_{7cycloalkyl})-(C₀-C₃ alkyl)—, (4— to 6—membered heterocycle)-(C₀-C₃ alkyl)—, (5— to 10-membered monocyclic or bicyclic aryl)-(C₀-C₃ alkyl)—, (5— to 10-membered monocyclic or bicyclic heteroaryl)-(C₀-C₃ alkyl)—,—OR^{x}, —SR^{x}, and —NR^{x}R^{y}, each of which may be optionally substituted with one or more Y groups as allowed by valency; and

Y is independently selected at each occurrence from alkyl, haloalkyl, alkoxy, alkenyl, alkynyl, aryl, heteroaryl, cycloalkyl, heterocycle, aldehyde, amino, carboxylic acid, ester, ether, halo, hydroxy, keto, nitro, cyano, azido, oxo, silyl, sulfo-oxo, sulfonyl, sulfone, sulfoxide, sulfonylamino, or thiol.

In some aspects of Formula I, A¹ is phenyl optionally substituted with one or more groups selected from R^{x}.

In some aspects of Formula I, n is 3. In some aspects of Formula I, n is 4. In some aspects of Formula I, n is 5. In some aspects of Formula I, n is 6.

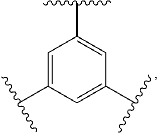 [SMILES: *c1cc(*)cc(*)c1]

In some aspects of Formula I, n is 3, and A¹ is wherein [symbol] is the point of attachment to each of —L¹—A²—(A³)ₘ—A⁴.

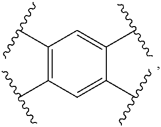 [SMILES: *c1cc(*)c(*)cc1*]

In some aspects of Formula I, n is 4, and A¹ is wherein [symbol] is the point of attachment to each of —L¹—A²—(A³)ₘ—A⁴.

In some aspects of Formula I, n is 6, and A¹ is

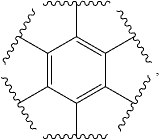

wherein [symbol] is the point of attachment to each of —L¹—A²—(A³)ₘ—A⁴.

In another aspect, a star polymer of Formula II:

[A⁴—(A³)ₘ—A²—L¹]ₙ·—A^{1′}—L³—A^{1′}—[L¹—A²—(A³)ₘ—A⁴]ₙ′ (II)

A^{1′} is independently at each occurrence 6—to 10-membered monocyclic or bicyclic aryl optionally substituted with one or more groups selected from R″:

n′ is independently at each occurrence an integer selected from 2, 3, 4, or 5 as allowed by valency;

L³ is —A¹⁰—L⁴—A¹¹—:

A¹⁰ and A¹¹ are independently

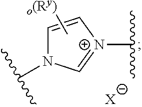

L⁴ is selected from C₁-C₁₂ alkyl, (C₁-C₆ alkyl)(phenylene)(C₁-C₆ alkyl), poly(ethylene glycol), poly(propylene glycol), poly(lactic acid), poly(glycolic acid), and poly(lactic acid-co-glycolic acid);

L¹ is independently selected at each occurrence from a bond and —A⁵—A⁶—;

A⁵ is independently selected at each occurrence from the group consisting of a bond, —NH—,—O—,—C(═O)—,—NHC(═O)—,—C(═O)NH—,—OC(═O)—, and —C(═O)O—;

A⁶ is independently selected at each occurrence from the group consisting of a bond and 6—to 10-membered monocyclic or bicyclic aryl optionally substituted with one or more groups selected from R^{x};

A² is independently at each occurrence

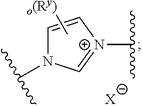

A³ is independently at each occurrence —L²—A⁷—;

m is independently selected at each occurrence from an integer greater than 3;

L² is independently selected at each occurrence from C₁-C₁₂ alkyl, poly(ethylene glycol), poly(propylene glycol), poly(lactic acid), poly(glycolic acid), and poly(lactic acid-co-glycolic acid);

A⁷ is independently selected at each occurrence from

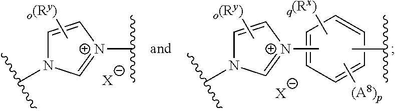

o is independently at each occurrence an integer selected from 0, 1, 2, and 3;

p is independently at each occurrence an integer selected from 1, 2, 3, and 4;

q is independently at each occurrence an integer selected from 0, 1, 2, or 3;

wherein p+q is equal to or less than 4;

A⁸ is independently at each occurrence —(A³)ₘ—A⁴;

A⁴ is independently at each occurrence —L²—A⁹;

A⁹ is independently selected at each occurrence from R^{w},

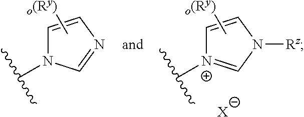

X is independently at each occurrence an anion;

R^{W} is independently selected at each occurrence from alkyl, haloalkyl, alkoxy, alkenyl, alkynyl, aryl, heteroaryl, cycloalkyl, heterocycle, aldehyde, amino, carboxylic acid, ester, ether, halo, hydroxy, keto, nitro, cyano, azido, oxo, silyl, sulfo-oxo, sulfonyl, sulfone, sulfoxide, sulfonylamino, and thiol;

R^{x} and R^{y} independently selected at each occurrence from hydrogen, halo, cyano, nitro, thiol, hydroxy, amino, azido, C₁-C₆ alkyl, C₁-C₆ haloalkyl, and C₁-C₆ alkoxy;

R^{z} is independently selected at each occurrence from hydrogen, C₁-C₆ alkyl, C₂-C₆ alkenyl, C₂-C₆ alkynyl, (C₃-C₆ cycloalkyl)(C₀-C₃ alkyl)—, (3— to 8-membered monocyclic or bicyclic heterocycle)-(C₀-C₃ alkyl)—, (6—to 10-membered monocyclic or bicyclic aryl)-(C₀-C₃ alkyl)—, and (5— to 10-membered monocyclic or bicyclic heteroaryl)-(C₀-C₃ alkyl)—, R^{a}O—(C₁-C₃ alkyl)—, R^{a}S—(C₁-C₃ alkyl)—, (R^{a}R^{b}N)—(C₁-C₃ alkyl)—, R^{a}O—C(O)—(C₀-C₃ alkyl)—, (R^{a}R^{b}N)—C(O)—(C₀-C₃ alkyl)—, R^{c}C(O)—O—(C₁-C₃ alkyl)—, R^{c}C(O)—(R^{a}N)—(C₁-C₃ alkyl)—, RCS(O)₂—O—(C₁-C₃ alkyl)—, RCS(O)₂—(R^{a}N)—(C₁-C₃ alkyl)—, R^{c}C(O)—(C₀-C₆ alkyl)—, and RCS(O)₂—(C₀-C₃ alkyl)—, each of which may be optionally substituted with one or more Y groups as allowed by valency:

R^{a} and R^{b} are independently selected at each occurrence from hydrogen, C₁-C₆alkyl, C₁-C₆haloalkyl, C₂-C₆alkenyl, C₂-C₆alkynyl, (C₃-C_{7cycloalkyl})-(C₀-C₃ alkyl)—, (4— to 6—membered heterocycle)-(C₀-C₃ alkyl)—, (5— to 10-membered monocyclic or bicyclic aryl)-(C₀-C₃ alkyl)—, (5— to 10-membered monocyclic or bicyclic heteroaryl)-(C₀-C₃ alkyl)—, each of which may be optionally substituted with one or more Y groups as allowed by valency:

R^{c} is independently selected at each occurrence from hydrogen, halo, C₁-C₆alkyl, C₁-C₆haloalkyl, C₂-C₆alkenyl, C₂-C₆alkynyl, (C₃-C_{7cycloalkyl})-(C₀-C₃ alkyl)—, (4— to 6—membered heterocycle)-(C₀-C₃ alkyl)—, (5— to 10-membered monocyclic or bicyclic aryl)-(C₀-C₃ alkyl)—, (5— to 10-membered monocyclic or bicyclic heteroaryl)-(C₀-C₃ alkyl)—,—OR^{x}, —SRY, and —NR″R^{y}, each of which may be optionally substituted with one or more Y groups as allowed by valency; and

Y is independently selected at each occurrence from alkyl, haloalkyl, alkoxy, alkenyl, alkynyl, aryl, heteroaryl, cycloalkyl, heterocycle, aldehyde, amino, carboxylic acid, ester, ether, halo, hydroxy, keto, nitro, cyano, azido, oxo, silyl, sulfo-oxo, sulfonyl, sulfone, sulfoxide, sulfonylamino, or thiol.

In some aspects of Formula II, L⁴ is C₁-C₁₂ alkyl. In some aspects of Formula II, L⁴ is selected from C₁ alkyl (i.e., methyl), C₂ alkyl (i.e., ethyl), C₃ alkyl (e.g., propyl and 1-methylethyl), C₄ alkyl (e.g., butyl, 1-methylpropyl, 2-methylpropyl, and 1,1,-dimethylethyl), Cs alkyl (e.g., pentyl), C₆ alkyl (e.g., hexyl), C₇ alkyl (e.g., heptyl), Cs alkyl (e.g., octyl), Co alkyl (e.g., nonyl), C₁₀ alkyl (e.g., decyl), C₁₁ alkyl (e.g., undecyl), and C₁₂ alkyl (e.g., dodecyl). In some aspects of Formula II, L⁴ is hexyl.

In some aspects of Formula II, L⁴ is (C₁-C₆ alkyl)(phenylene)(C₁-C₆ alkyl). In some aspects of Formula II, L⁴ is (C₁-C₃ alkyl)(phenylene)(C₁-C₃ alkyl). In some aspects of Formula II, L⁴ is

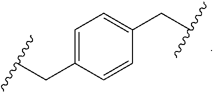 [SMILES: *Cc1ccc(C*)cc1]

In some aspects of Formula II, L⁴ is poly(ethylene glycol). In some aspects of Formula II, L⁴ is poly(propylene glycol). In some aspects of Formula II, L⁴ is poly(lactic acid). In some aspects of Formula II, L⁴ is poly(glycolic acid). In some aspects of Formula II, L⁴ is poly(lactic acid-co-glycolic acid).

In some aspects of Formula II, A¹⁰ and A¹¹ are each

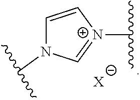

In some aspects of Formula II, each A^{1′} is independently phenyl optionally substituted with one or more groups selected from R^{x}.

In some aspects of Formula II, each n′ is 2. In some aspects of Formula II, each n′ is 2. In some aspects of Formula II, each n′ is 4. In some aspects of Formula II, each n′ is 5.

In some aspects of Formula II, each n′ is 2, and each A¹″ is

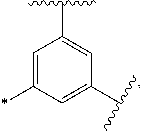 [SMILES: *c1cc(*)cc(*)c1]

wherein * is the point of attachment to L³ and [symbol] is the point of attachment to each of —L¹—A²—(A³)ₘ—A⁴.

In some aspects of Formula II, each n′ is 3, and each A¹″ is

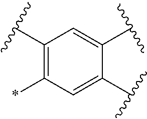 [SMILES: *c1cc(*)c(*)cc1*]

wherein * is the point of attachment to L³ and [symbol] is the point of attachment to each of —L′-A²—(A³)ₘ—A⁴.

In some aspects of Formula II, each n′ is 5, and each A¹″ is

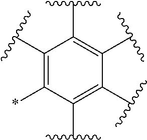 [SMILES: *c1c(*)c(*)c(*)c(*)c1*]

wherein * is the point of attachment to L³ and [symbol] is the point of attachment to each of —L¹—A²—(A³)ₘ—A⁴.

In some aspects of Formula I and Formula II, L′ is a bond. In some aspects of Formula I and Formula II, L′ is —A⁵—A⁶—.

In some aspects of Formula I and Formula II, A⁵ is a bond. In some aspects of Formula I and Formula II, A⁵ is —NH—. In some aspects of Formula I and Formula II, A⁵ is —O—. In some aspects of Formula I and Formula II, A⁵ is —C(═O)—. In some aspects of Formula I and Formula II, A⁵ is —NHC(═O)—. In some aspects of Formula I and Formula II, A⁵ is —C(═O)NH—. In some aspects of Formula I and Formula II, A⁵ is —OC(═O)—. In some aspects of Formula I and Formula II, A⁵ is —C(═O)O—.

In some aspects of Formula I and Formula II, A⁶ is a bond. In some aspects of Formula I and Formula II, A⁶ is 6—to 10-membered monocyclic or bicyclic aryl optionally substituted with one or more groups selected from R^{x}. In some aspects of Formula I and Formula II, A⁶ is phenyl optionally substituted with one or more groups selected from R^{x}.

In some aspects of Formula I and Formula II, L¹ is

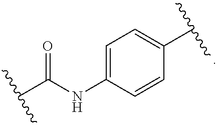 [SMILES: *C(=O)Nc1ccc(*)cc1]

In some aspects of Formula I and Formula II, A² is

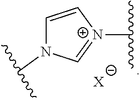

In some aspects of Formula I and Formula II, m is 4, 5, 6, 7, 8, 9, 10, 11, 12, 15, 20, 25, 30, 35, 40, 45, 50, 55, 60, 65, 70, 75, or 80. In some aspects of Formula I and Formula II, m is 4. In some aspects of Formula I and Formula II, m is 5. In some aspects of Formula I and Formula II, m is 6. In some aspects of Formula I and Formula II, m is 7. In some aspects of Formula I and Formula II, m is 8. In some aspects of Formula I and Formula II, m is 9. In some aspects of Formula I and Formula II, m is 10. In some aspects of Formula I and Formula II, m is 11. In some aspects of Formula I and Formula II, m is 12. In some aspects of Formula I and Formula II, m is 15. In some aspects of Formula I and Formula II, m is 20. In some aspects of Formula I and Formula II, m is 25. In some aspects of Formula I and Formula II, m is 30. In some aspects of Formula I and Formula II, m is 35. In some aspects of Formula I and Formula II, m is 40. In some aspects of Formula I and Formula II, m is 45. In some aspects of Formula I and Formula II, m is 50. In some aspects of Formula I and Formula II, m is 55. In some aspects of Formula I and Formula II, m is 60. In some aspects of Formula I and Formula II, m is 65. In some aspects of Formula I and Formula II, m is 70. In some aspects of Formula I and Formula II, m is 75. In some aspects of Formula I and Formula II, m is 80.

In some aspects of Formula I and Formula II, L² is C₁-C₁₂ alkyl. In some aspects of Formula I and Formula II, L² is selected from C₁ alkyl (i.e., methyl), C₂ alkyl (i.e., ethyl), C₃ alkyl (e.g., propyl and 1-methylethyl), C₄ alkyl (e.g., butyl, 1-methylpropyl, 2-methylpropyl, and 1,1-dimethylethyl), Cs alkyl (e.g., pentyl), C₆ alkyl (e.g., hexyl), C₇ alkyl (e.g., heptyl), Cs alkyl (e.g., octyl), Co alkyl (e.g., nonyl), C₁₀ alkyl (e.g., decyl), Cu alkyl (e.g., undecyl), and C₁₂ alkyl (e.g., dodecyl). In some aspects of Formula I and Formula II, L² is hexyl.

In some aspects of Formula I and Formula II, L² is poly(ethylene glycol). In some aspects of Formula I and Formula II, L² is poly(propylene glycol). In some aspects of Formula I and Formula II, L⁴=2 is poly(lactic acid). In some aspects of Formula I and Formula II, L² is poly(glycolic acid). In some aspects of Formula I and Formula II, L² is poly(lactic acid-co-glycolic acid).

In some aspects of Formula I and Formula II, A⁷ is

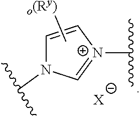

In some aspects of Formula I and Formula II, A⁷ is

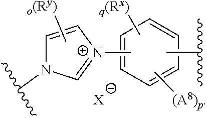

In some aspects of Formula I and Formula II, A⁷ is

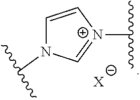

In some aspects of Formula I and Formula II, A⁷ is

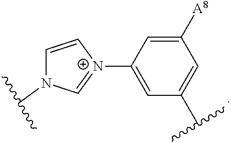

In some aspects of Formula I and Formula II, A⁹ is R″.

In some aspects of Formula I and Formula II, A⁹ is

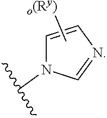

In some aspects of Formula I and Formula II, A⁹ is

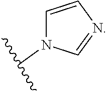 [SMILES: *n1ccnc1]

In some aspects of Formula I and Formula II, A⁹ is

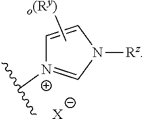

In some aspects of Formula I and Formula II, A⁹ is

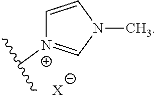

In some aspects of Formula I and Formula II, A⁹ is

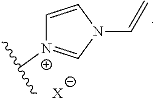

In some aspects of Formula I and Formula II, A⁹ is A⁹ is

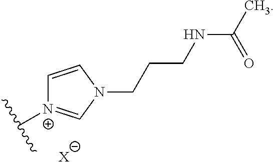

In some aspects of Formula I and Formula II, X is a halide. In some aspects of Formula I and Formula II, X is selected from chloride, bromide, and iodide. In some aspects of Formula I and Formula II, X is a carboxylate. In some aspects of Formula I and Formula II, X is acetate. In some aspects of Formula I and Formula II, X is a sulfonate. In some aspects of Formula I and Formula II, X is selected from trifluoromethyl sulfonate, methyl sulfonate, and 4-methylphenylsulfonate. In some aspects of Formula I and Formula II, X is a sulfonimide. In some aspects of Formula I and Formula II, X is bistriflimide). In some aspects of Formula I and Formula II, X is a borate. In some aspects of Formula I and Formula II, X is selected from tetrafluoroborate or tetrakis[3,5-bis(trifluoromethyl)phenyl]borate. In some aspects of Formula I and Formula II, X is hexafluorophosphate.

Representative examples of star polymers described herein include, but are not limited to:

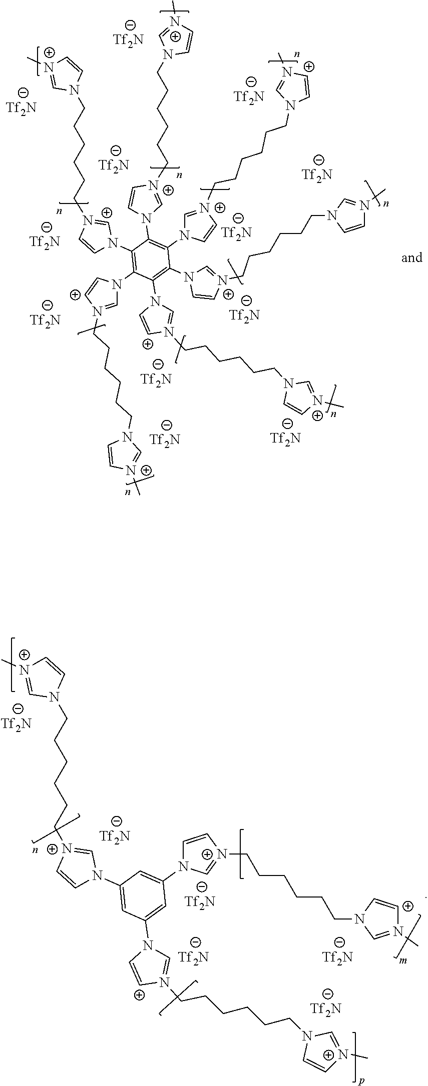

### Methods of Making

In another aspect, methods of making the polymers described herein are also provided.

In one aspect, a method is provided for synthesizing a star polymer described herein, comprising:
a) reacting a compound of Formula III

LG¹—L²—LG² (III)

with a compound of Formula IV

H—A⁷ (IV)

to form a compound of Formula V

LG¹—L²—A⁷ (V);
b) reacting the compound of Formula V with a compound of Formula VI or Formula VII

A¹—[L¹—A^{2′}]ₙ (VI) or

[A^{2′}—L¹]ₙ′—A^{1′}—L³—A^{1′}—[L¹—A^{2′}]ₙ′ (VII)

to form the star polymer;

and optionally c) treating the star polymer with an end capping agent R^{w}—LG³;

wherein:

LG¹, LG², and LG³ are each a leaving group;

A⁷″ is selected from

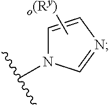

A^{2′} is selected from

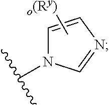

and all other variables are as defined herein.

In some aspects, LG¹ and LG² are each independently halo (for example, independently chloro, bromo, or iodo). In some aspects, LG¹ is chloro, and LG² is bromo.

In some aspects, A⁷ is

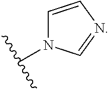 [SMILES: *n1ccnc1]

In some aspects, the compound of Formula V is

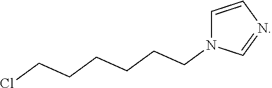 [SMILES: ClCCCCCCn1ccnc1]

“Leaving group,” as used herein, refers to a molecule or a molecular fragment (e.g., an anion) that is displaced in a chemical reaction as a stable species, taking with it the bonding electrons. Examples of leaving groups include arylsulfonyloxy groups or alkylsulfonyloxy groups, such as mesylate or tosylate. Common anionic leaving groups also include halides such as Cl⁻, Br⁻, and I⁻.

Variations on compounds used in the processes for the preparation of compounds of Formula I or Formula II can include the addition, subtraction, or movement of various constituents as described for each compound. Similarly, when one or more chiral centers is present in a molecule, the chirality of the molecule can be changed. Additionally, the synthesis of the compounds used in these processes can involve the protection of various chemical groups, and further, the compounds of Formula I or Formula II prepared by the disclosed processes may be subsequently deprotected as appropriate. The use of protection and deprotection and the selection of appropriate protecting groups would be readily known to one skilled in the art. “Protecting group,” as used herein, refers to any conventional functional group that allows one to obtain chemoselectivity in a subsequent chemical reaction. Protecting groups are described, for example, in Peter G. M. Wuts, Greene's Protective Groups in Organic Synthesis, 5th Ed., Wiley & Sons, 2014. For a particular compound and/or a particular chemical reaction, a person skilled in the art knows how to select and implement appropriate protecting groups and their associated synthetic methods. Examples of amine-protecting groups include acyl and alkoxy carbonyl groups, such as t-butoxycarbonyl (BOC) and [2—(trimethylsilyl)ethoxy]methoxy (SEM). Examples of carboxyl-protecting groups include C₁-C₆ alkoxy groups, such as methyl, ethyl, and t-butyl. Examples of alcohol-protecting groups include benzyl, trityl, silyl ethers, and the like.

The described processes, or reactions to produce the compounds used in the described processes, can be carried out in solvents indicated herein or in solvents that can be selected by one skilled in the art of organic synthesis. Solvents can be substantially nonreactive with the starting materials (reactants), intermediates, or products under the conditions at which the reaction is carried out, i.e., temperature and pressure. Reactions can be carried out in one solvent or a mixture of more than one solvent. Product or intermediate formation can be monitored according to any suitable method known in the art. For example, product formation can be monitored by spectroscopic means, such as nuclear magnetic resonance spectroscopy (e.g., ¹H and ¹³C), infrared spectroscopy, spectrophotometry (e.g., UV-visible), mass spectrometry, or chromatography such as high-performance liquid chromatography (HPLC) or thin layer chromatography (TLC). Uses

The star polymers described herein may find use in a number of applications where star and/or ionene polymers are presently utilized. Representative examples include, but are not limited to: use as interfacial stabilizing agents: in drug delivery and encapsulation; imaging (such as MRI): in nanoreactors and catalysis: as viscosity modifiers: as gelling agents in cosmetics: in adhesives, sealants, and coatings: in membrane-based separations: as thickeners, film formers, or conditions in cosmetics: in stimuli-responsive materials or 3D printing: in antimicrobial biomedical materials and devices: in materials for solar cells and batteries: in absorbent materials for dyes or oil: in nanoparticle synthesis; and hydrogels. Benefits of the star polymers described herein as compared to linear ionenes include, but are not limited to, lowered viscosity, higher density and compact structures, assembly and domain-based structuring, and unique rheological behaviors.

### Further Aspects

In view of the described compounds, compositions, and methods, hereinbelow are described certain more particular aspects of the disclosure. These particularly recited aspects should not, however, be interpreted to have any limiting effect on any different claims containing different or more general teachings described herein or that the “particular” aspects are somehow limited in some way other than the inherent meanings of the language and formulas literally used therein.
Aspect 1. A star polymer of Formula I:

A¹—[L¹—A²—(A³)ₘ—A⁴]ₙ (I)

wherein:

A¹ is 6—to 10-membered monocyclic or bicyclic aryl optionally substituted with one or more groups selected from R^{x};

n is an integer selected from 3, 4, 5, or 6 as allowed by valency;

L¹ is independently selected at each occurrence from a bond and —A⁵—A⁶—;

A⁵ is independently selected at each occurrence from the group consisting of a bond, —NH—,—O—,—C(═O)—,—NHC(═O)—,—C(═O)NH—,—OC(═O)—, and —C(═O)O—;

A⁶ is independently selected at each occurrence from the group consisting of a bond and 6—to 10-membered monocyclic or bicyclic aryl optionally substituted with one or more groups selected from R^{x};

A² is independently at each occurrence

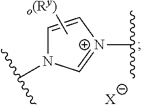

A³ is independently at each occurrence —L²—A⁷—;

m is independently selected at each occurrence from an integer greater than 3;

L² is independently selected at each occurrence from C₁-C₁₂ alkyl, poly(ethylene glycol), poly(propylene glycol), poly(lactic acid), poly(glycolic acid), and poly(lactic acid-co-glycolic acid);

A⁷ is independently selected at each occurrence from

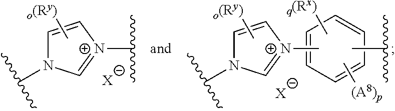

o is independently at each occurrence an integer selected from 0, 1, 2, and 3;

p is independently at each occurrence an integer selected from 1, 2, 3, and 4;

q is independently at each occurrence an integer selected from 0, 1, 2, or 3:

wherein p+q is equal to or less than 4;

A⁸ is independently at each occurrence —(A³)ₘ—A⁴:

A⁴ is independently at each occurrence —L²—A⁹:

A⁹ is independently selected at each occurrence from R^{w},

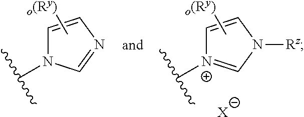

X is independently at each occurrence an anion;

R^{W} is independently selected at each occurrence from alkyl, haloalkyl, alkoxy, alkenyl, alkynyl, aryl, heteroaryl, cycloalkyl, heterocycle, aldehyde, amino, carboxylic acid, ester, ether, halo, hydroxy, keto, nitro, cyano, azido, oxo, silyl, sulfo-oxo, sulfonyl, sulfone, sulfoxide, sulfonylamino, and thiol;

R^{x} and R^{y} independently selected at each occurrence from hydrogen, halo, cyano, nitro, thiol, hydroxy, amino, azido, C₁-C₆ alkyl, C₁-C₆ haloalkyl, and C₁-C₆ alkoxy:

R^{z} is independently selected at each occurrence from hydrogen, C₁-C₆ alkyl, C₂-C₆ alkenyl, C₂-C₆ alkynyl, (C₃-C₆ cycloalkyl)(C₀-C₃ alkyl)—, (3— to 8-membered monocyclic or bicyclic heterocycle)-(C₀-C₃ alkyl)—, (6—to 10-membered monocyclic or bicyclic aryl)-(C₀-C₃ alkyl)—, and (5— to 10-membered monocyclic or bicyclic heteroaryl)-(C₀-C₃ alkyl)—, R^{a}O—(C₁-C₃ alkyl)—, R^{a}S—(C₁-C₃ alkyl)—, (R^{a}REN)—(C₁-C₃ alkyl)—, R^{a}O—C(O)—(C₀-C₃ alkyl)—, (R^{a}RDN)—C(O)—(C₀-C₃ alkyl)—, R^{c}C(O)—O—(C₁-C₃ alkyl)—, R^{c}C(O)—(R^{a}N)—(C₁-C₃ alkyl)—, RCS(O)₂—O—(C₁-C₃ alkyl)—, RCS(O)₂—(R^{a}N)—(C₁-C₃ alkyl)—, R^{c}C(O)—(C₀-C₆ alkyl)—, and RCS(O)₂—(C₀-C₃ alkyl)—, each of which may be optionally substituted with one or more Y groups as allowed by valency:

R^{a} and R^{b} are independently selected at each occurrence from hydrogen, C₁-C₆alkyl, C₁-C₆haloalkyl, C₂-C₆alkenyl, C₂-C₆alkynyl, (C₃-C_{7cycloalkyl})-(C₀-C₃ alkyl)—, (4— to 6—membered heterocycle)-(C₀-C₃ alkyl)—, (5— to 10-membered monocyclic or bicyclic aryl)-(C₀-C₃ alkyl)—, (5— to 10-membered monocyclic or bicyclic heteroaryl)-(C₀-C₃ alkyl)—, each of which may be optionally substituted with one or more Y groups as allowed by valency:

R^{c} is independently selected at each occurrence from hydrogen, halo, C₁-C₆alkyl, C₁-C₆haloalkyl, C₂-C₆alkenyl, C₂-C₆alkynyl, (C₃-C_{7cycloalkyl})-(C₀-C₃ alkyl)—, (4— to 6—membered heterocycle)-(C₀-C₃ alkyl)—, (5— to 10-membered monocyclic or bicyclic aryl)-(C₀-C₃ alkyl)—, (5— to 10-membered monocyclic or bicyclic heteroaryl)-(C₀-C₃ alkyl)—,—OR^{x}, —SR^{x}, and —NR^{x}R^{y}, each of which may be optionally substituted with one or more Y groups as allowed by valency; and

Y is independently selected at each occurrence from alkyl, haloalkyl, alkoxy, alkenyl, alkynyl, aryl, heteroaryl, cycloalkyl, heterocycle, aldehyde, amino, carboxylic acid, ester, ether, halo, hydroxy, keto, nitro, cyano, azido, oxo, silyl, sulfo-oxo, sulfonyl, sulfone, sulfoxide, sulfonylamino, or thiol.
Aspect 2. The star polymer of aspect 1, wherein n is 3, and A¹ is

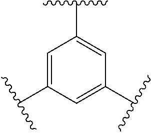

wherein [symbol] is the point of attachment to each of —L¹—A²—(A³)ₘ—A⁴.
Aspect 3. The star polymer of aspect 1, wherein n is 4, and A¹ is

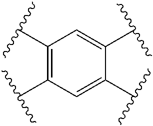

wherein [symbol] is the point of attachment to each of —L¹—A²—(A³)ₘ—A⁴.
Aspect 4. The star polymer of aspect 1, wherein n is 6, and A¹ is

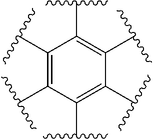

wherein [symbol] is the point of attachment to each of —L¹—A²—(A³)ₘ—A⁴.
Aspect 5. A star polymer of Formula II:

[A⁴—(A³)ₘ—A²—L¹]ₙ′—A^{1′}—L³—A^{1′}—[L¹—A²—(A³)ₘ—A⁴]ₙ′ (II)

A^{1′} is independently at each occurrence 6—to 10-membered monocyclic or bicyclic aryl optionally substituted with one or more groups selected from R″;

n′ is independently at each occurrence an integer selected from 2, 3, 4, or 5 as allowed by valency;

L³ is —A¹⁰—L⁴—A¹¹—;

A¹⁰ and A¹¹ are independently

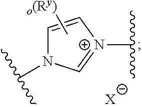

L⁴ is selected from C₁-C₁₂ alkyl, (C₁-C₆ alkyl)(phenylene)(C₁-C₆ alkyl), poly(ethylene glycol), poly(propylene glycol), poly(lactic acid), poly(glycolic acid), and poly(lactic acid-co-glycolic acid);

L¹ is independently selected at each occurrence from a bond and —A⁵—A⁶—;

A⁵ is independently selected at each occurrence from the group consisting of a bond, —NH—,—O—,—C(═O)—,—NHC(═O)—,—C(═O)NH—,—OC(═O)—, and —C(═O)O—;

A⁶ is independently selected at each occurrence from the group consisting of a bond and 6—to 10-membered monocyclic or bicyclic aryl optionally substituted with one or more groups selected from R^{x};

A² is independently at each occurrence

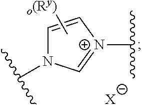

A³ is independently at each occurrence —L²—A⁷—; m is independently selected at each occurrence from an integer greater than 3;

L² is independently selected at each occurrence from C₁-C₁₂ alkyl, poly(ethylene glycol), poly(propylene glycol), poly(lactic acid), poly(glycolic acid), and poly(lactic acid-co-glycolic acid);

A⁷ is independently selected at each occurrence from

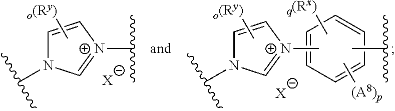

o is independently at each occurrence an integer selected from 0, 1, 2, and 3;

p is independently at each occurrence an integer selected from 1, 2, 3, and 4;

q is independently at each occurrence an integer selected from 0, 1, 2, or 3;

wherein p+q is equal to or less than 4;

A⁸ is independently at each occurrence —(A³)ₘ—A⁴;

A⁴ is independently at each occurrence —L²—A⁹;

A⁹ is independently selected at each occurrence from R^{w},

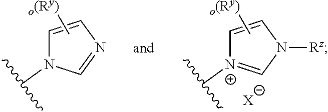

X is independently at each occurrence an anion;

R^{W} is independently selected at each occurrence from alkyl, haloalkyl, alkoxy, alkenyl, alkynyl, aryl, heteroaryl, cycloalkyl, heterocycle, aldehyde, amino, carboxylic acid, ester, ether, halo, hydroxy, keto, nitro, cyano, azido, oxo, silyl, sulfo-oxo, sulfonyl, sulfone, sulfoxide, sulfonylamino, and thiol;

R^{x} and R^{y} independently selected at each occurrence from hydrogen, halo, cyano, nitro, thiol, hydroxy, amino, azido, C₁-C₆ alkyl, C₁-C₆ haloalkyl, and C₁-C₆ alkoxy:

R^{z} is independently selected at each occurrence from hydrogen, C₁-C₆ alkyl, C₂-C₆ alkenyl, C₂-C₆ alkynyl, (C₃-C₆ cycloalkyl)(C₀-C₃ alkyl)—, (3— to 8-membered monocyclic or bicyclic heterocycle)-(C₀-C₃ alkyl)—, (6—to 10-membered monocyclic or bicyclic aryl)-(C₀-C₃ alkyl)—, and (5— to 10-membered monocyclic or bicyclic heteroaryl)-(C₀-C₃ alkyl)—, R^{a}O—(C₁-C₃ alkyl)—, R^{a}S—(C₁-C₃ alkyl)—, (R^{a}R^{b}N)—(C₁-C₃ alkyl)—, R^{a}O—C(O)—(C₀-C₃ alkyl)—, (R^{a}R^{b}N)—C(O)—(C₀-C₃ alkyl)—, R^{c}C(O)—O—(C₁-C₃ alkyl)—, R^{c}C(O)—(R^{a}N)—(C₁-C₃ alkyl)—, RCS(O)₂—O—(C₁-C₃ alkyl)—, RCS(O)₂—(R^{a}N)—(C₁-C₃ alkyl)—, R^{c}C(O)—(C₀-C₆ alkyl)—, and RCS(O)₂—(C₀-C₃ alkyl)—, each of which may be optionally substituted with one or more Y groups as allowed by valency:

R^{a} and R^{b} are independently selected at each occurrence from hydrogen, C₁-C₆alkyl, C₁-C₆haloalkyl, C₂-C₆alkenyl, C₂-C₆alkynyl, (C₃-C_{7cycloalkyl})-(C₀-C₃ alkyl)—, (4— to 6—membered heterocycle)-(C₀-C₃ alkyl)—, (5— to 10-membered monocyclic or bicyclic aryl)-(C₀-C₃ alkyl)—, (5— to 10-membered monocyclic or bicyclic heteroaryl)-(C₀-C₃ alkyl)—, each of which may be optionally substituted with one or more Y groups as allowed by valency:

R^{c} is independently selected at each occurrence from hydrogen, halo, C₁-C₆alkyl, C₁-C₆haloalkyl, C₂-C₆alkenyl, C₂-C₆alkynyl, (C₃-C_{7cycloalkyl})-(C₀-C₃ alkyl)—, (4— to 6—membered heterocycle)-(C₀-C₃ alkyl)—, (5— to 10-membered monocyclic or bicyclic aryl)-(C₀-C₃ alkyl)—, (5— to 10-membered monocyclic or bicyclic heteroaryl)-(C₀-C₃ alkyl)—,—OR, —SR^{x}, and —NR″R^{y}, each of which may be optionally substituted with one or more Y groups as allowed by valency; and

Y is independently selected at each occurrence from alkyl, haloalkyl, alkoxy, alkenyl, alkynyl, aryl, heteroaryl, cycloalkyl, heterocycle, aldehyde, amino, carboxylic acid, ester, ether, halo, hydroxy, keto, nitro, cyano, azido, oxo, silyl, sulfo-oxo, sulfonyl, sulfone, sulfoxide, sulfonylamino, or thiol.
Aspect 6. The star polymer of aspect 5, wherein L⁴ is C₁-C₁₂ alkyl.
Aspect 7. The star polymer of aspect 6, wherein L⁴ is hexyl.
Aspect 8. The star polymer of aspect 5, wherein L⁴ is (C₁-C₆ alkyl)(phenylene)(C₁-C₆ alkyl).
Aspect 9. The star polymer of aspect 8, wherein L⁴ is

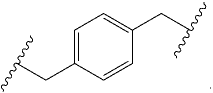 [SMILES: *Cc1ccc(C*)cc1]

Aspect 10. The star polymer of any one of aspects 5—9, wherein A¹⁰ and A¹¹ are each

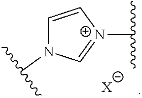

Aspect 11. The star polymer of any one of aspects 5—10, wherein each n′ is 2, and each A^{1′} is

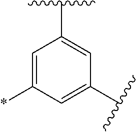 [SMILES: *c1cc(*)cc(*)c1]

wherein * is the point of attachment to L³ and [symbol] is the point of attachment to each of —L¹—A²—(A³)ₘ—A⁴.
Aspect 12. The star polymer of any one of aspects 5—10, wherein each n′ is 3, and each A^{1′} is

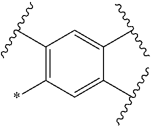 [SMILES: *c1cc(*)c(*)cc1*]

wherein * is the point of attachment to L³ and [symbol] is the point of attachment to each of —L¹—A²—(A³)ₘ—A⁴.
Aspect 13. The star polymer of any one of aspects 5—10, wherein each n′ is 5, and each A^{1′} is

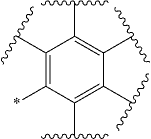 [SMILES: *c1c(*)c(*)c(*)c(*)c1*]

wherein * is the point of attachment to L³ and [symbol] is the point of attachment to each of —L¹—A²—(A³)ₘ—A⁴.
Aspect 14. The star polymer of any one of aspects 1—13, wherein L¹ is a bond.
Aspect 15. The star polymer of any one of aspects 1—13, wherein L¹ is —A⁵—A⁶
Aspect 16. The star polymer of aspect 15, wherein A⁵ is —C(═O)NH—.
Aspect 17. The star polymer of aspect 15 or aspect 16, wherein A⁶ is phenyl optionally substituted with one or more groups selected from R^{x}.
Aspect 18. The star polymer of aspect 15, wherein L¹ is

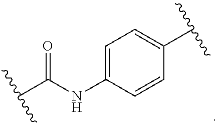 [SMILES: *C(=O)Nc1ccc(*)cc1]

Aspect 19. The star polymer of any one of aspects 1—18, wherein A² is

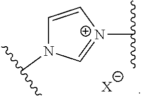

Aspect 20. The star polymer of any one of aspects 1—19, wherein m is 4, 5, 6, 7, 8, 9, 10, 11, 12, 15, 20, 25, 30, 35, 40, 45, 50, 55, 60, 65, 70, 75, or 80.
Aspect 21. The star polymer of any one of aspects 1—20, wherein L² is C₁-C₁₂ alkyl.
Aspect 22. The star polymer of aspect 21, wherein L² is hexyl.
Aspect 23. The star polymer of any one of aspects 1—22, wherein A⁷ is

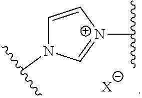

Aspect 24. The star polymer of any one of aspects 1—22, wherein A⁷ is

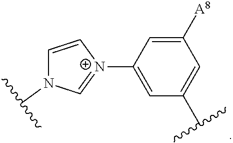

Aspect 25. The star polymer of any one of aspects 1—24, wherein A⁹ is R″.
Aspect 26. The star polymer of any one of aspects 1—24, wherein A⁹ is

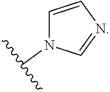 [SMILES: *n1ccnc1]

Aspect 27. The star polymer of any one of aspects 1—24, wherein A⁹ is

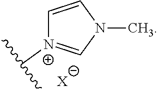

Aspect 28. The star polymer of any one of aspects 1—24, wherein A⁹ is

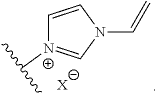

Aspect 29. The star polymer of any one of aspects 1—24, wherein A⁹ is

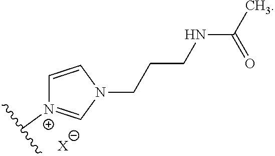

Aspect 30. The star polymer of any one of aspects 1—29, wherein each X is independently selected from the group consisting of a halide (such as chloride, bromide, or iodide), a carboxylate (such as acetate), a sulfonate (such as trifluoromethyl sulfonate, methyl sulfonate, or 4-methylphenylsulfonate), a sulfonimide (such as bistriflimide), a borate (such a tetrafluoroborate or tetrakis[3,5-bis(trifluoromethyl)phenyl]borate), or hexafluorophosphate.

A number of aspects of the disclosure have been described. Nevertheless, it will be understood that various modifications may be made without departing from the spirit and scope of the invention. Accordingly, other aspects are within the scope of the following claims.

By way of non-limiting illustration, examples of certain aspects of the present disclosure are given below.

### Examples

The following examples are put forth to provide those of ordinary skill in the art with a complete disclosure and description of how the compounds, compositions, and methods claimed herein are made and evaluated and are intended to be purely exemplary of the invention and are not intended to limit the scope of what the inventors regard as their invention. Efforts have been made to ensure accuracy concerning numbers (e.g., amounts, temperature, etc.), but some errors and deviations should be accounted for. Unless indicated otherwise, parts are parts by weight, temperature is in degrees Celsius or is at ambient temperature, and pressure is at or near atmospheric pressure.

### Synthesis of Star Ionenes

### Preparation of 1-chlorohexylimidazole

Synthetic methods adapted from Suckow, et al. (Synthesis of polymeric ionic liquids with unidirectional chain topology by AB step growth polymerization. Polymer 2017, 111, 123—129).

Imidazole (147 mmol, 10.0 g) was stirred at room temperature for 1 h in 50 mL of THF in a 250 ml two-neck round-bottom flask equipped with a stir bar and a N₂ balloon. The reaction vessel was cooled on a chilled plate (2° C.) for 30 min, and sodium hydride (60% in mineral oil) (162 mmol, 6.47 g) was slowly added carefully. The mixture was stirred chilled at 2° C. for 2 h, then 1-chloro-6-bromohexane (147 mmol, 29.3 g) was added carefully. After the reactant was added, the chilled reaction temperature was maintained for 2 h then the chiller was removed to allow the reaction to come to room temperature while stirring for 8 h. After the reaction, 200 ml of deionized (DI) water was added. Then, the reaction mixture was extracted with DCM, washed with water and dried over Na₂SO₄. This solution was diluted with 50 mL of DMF before the DCM was removed via rotary evaporation to inhibit auto-polymerization, and the crude yellow oily solution was then concentrated for use in the next step.

### Preparation of star ionenes with tri—and hexa-imidazolium benzene cores and hexyl-spaced imidazolium bistriflimide arms

1,3,5-triimidazolebenzene, 1,2,4,5-tetraimidazolebenzene, and 1,2,3,4,5,6-hexaimidazolebenzene were synthesized from bromo—or fluoro-benzene precursors and imidazole via Ullmann coupling, as described previously (see O'Harra, K. E.: DeVriese, E. M.: Turflinger, E. M.: Noll, D. M.: Bara, J. E., Design and Gas Separation Performance of Imidazolium Poly(ILs) Containing Multivalent Imidazolium Fillers and Crosslinking Agents. Polymers 2021, 13 (9)). These were precipitated in water and purified to yield bright white solids.

Three prototypical imidazolium-benzene star ionenes were targeted and synthesized according to the following methods, resulting in star polymers with 3 or 6 arms attached to the imidazole-benzene cores, each with 25 (hexaimidazolium benzene core) or 35 vs. 70 (triimidazolium benzene core) repeating units (C₆ or hexyl-spaced imidazolium bistriflimide segments) per arm of each star were achieved. Optimization of these ratios and the starting core allow for access to differing numbers of arms and arm lengths in these star ionene formulations. Analysis can be optimized via “marking” the peripheral end of each arm via methylation to the N-methyl-imidazolium form. Some residual mineral oil and DMF were observed but could readily be removed via additional purification.

1,3,5-triimidazolebenzene (0.05 g, 0.18 mmol) was added with DMF (80 mL) to a 250 mL heavy-walled round-bottom pressure flask (Ace Glass, Vineland, NJ, USA) equipped with a stir bar. The 1-chlorohexylimidazole monomer (38 mmol, 7.1 g) in DMF was added, and the vessel was sealed with a PTFE screw cap with a Kalrez O-ring. The mixture was heated to 100° C. while stirring for 16 h, then was cooled to room temperature (RT). The solution was then poured into a solution of LiTf₂N (46 mmol, 13.1 g) in deionized (DI) water and allowed to stir at RT for 2 h to promote anion metathesis from the Cl⁻ salt and precipitate the product as the Tf₂N⁻ salt. The tacky precipitate was separated and dried in an oven (Symphony Vacuum Oven, VWR, Radnor, PA, USA) at 100° C. overnight to yield the star ionene as a pale green, waxy, soft solid.

According to a similar procedure, 1,3,5-triimidazolebenzene (0.10 g, 0.36 mmol) was reacted in DMF with the 1-chlorohexylimidazole monomer (38 mmol, 7.1 g) in DMF in a round-bottom pressure flask at 100° C. for 16 h. The star ionene was exchanged to the hydrophobic Tf₂N salt via precipitation in aqueous LiTf₂N (46 mmol, 13.1 g) solution. The precipitate was separated and dried at 100° C., overnight to yield the star ionene as a pale green tough waxy solid.

According to a similar procedure, 1,2,3,4,5,6-hexaimidazolebenzene (0.05 g, 0.105 mmol) was reacted in DMF with the 1-chlorohexylimidazole monomer (16 mmol, 2.94 g) in DMF in a round-bottom pressure flask at 100° C. for 16 h. The star ionene was exchanged to the hydrophobic Tf₂N⁻ salt via precipitation in aqueous LiTf₂N (17.3 mmol, 4.97 g) solution. The precipitate was separated and dried at 100° C., overnight to yield the star ionene as a pale yellow waxy solid.

The compositions and methods of the appended claims are not limited in scope by the specific compositions and methods described herein, which are intended as illustrations of a few aspects of the claims, and any compositions and methods that are functionally equivalent are intended to fall within the scope of the claims. Various modifications of the compositions and methods, in addition to those shown and described herein, are intended to fall within the scope of the appended claims. Further, while only certain representative compositions and method steps disclosed herein are specifically described, other combinations of the compositions and method steps are also intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. A star polymer of Formula I or Formula II:
A¹—[L¹—A²—(A³)ₘ—A⁴]ₙ (I) or
[A⁴—(A³)ₘ—A²—L¹]ₙ′—A^{1′}—L³—A^{1′}—[L¹—A²—(A³)ₘ—A⁴]ₙ′ (II)
wherein:
A¹ is 6—to 10-membered monocyclic or bicyclic aryl optionally substituted with one or more groups selected from R^{x};
A^{1′} is independently at each occurrence 6—to 10-membered monocyclic or bicyclic aryl optionally substituted with one or more groups selected from R″;
A² is independently at each occurrence 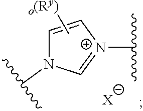
A³ is independently at each occurrence —L²—A⁷—;
A⁴ is independently at each occurrence —L²—A⁹;
A⁵ is independently selected at each occurrence from the group consisting of a bond, —NH—,—O—,—C(═O)—,—NHC(═O)—,—C(═O)NH—,—OC(═O)—, and —C(═O)O—;
A⁶ is independently selected at each occurrence from the group consisting of a bond and 6—to 10-membered monocyclic or bicyclic aryl optionally substituted with one or more groups selected from R^{x};
A⁷ is independently selected at each occurrence from 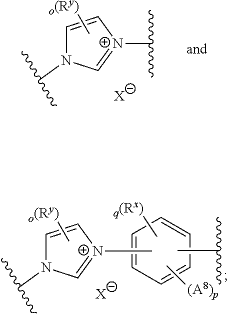
A⁸ is independently at each occurrence —(A³)ₘ—A⁴;
A⁹ is independently selected at each occurrence from R^{w}, 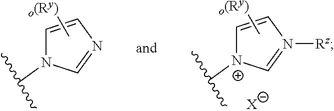 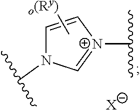
A¹⁰ and A¹¹ are independently
L¹ is independently selected at each occurrence from a bond and —A⁵—A⁶—;
L² is independently selected at each occurrence from C₁-C₁₂ alkyl, poly(ethylene glycol), poly(propylene glycol), poly(lactic acid), poly(glycolic acid), and poly(lactic acid-co-glycolic acid);
L³ is —A¹⁰—L⁴—A¹¹—;
L⁴ is selected from C₁-C₁₂ alkyl, (C₁-C₆ alkyl)(phenylene)(C₁-C₆ alkyl), poly(ethylene glycol), poly(propylene glycol), poly(lactic acid), poly(glycolic acid), and poly(lactic acid-co-glycolic acid);
m is independently selected at each occurrence from an integer greater than 3;
n is an integer selected from 3, 4, 5, or 6 as allowed by valency;
n′ is independently at each occurrence an integer selected from 2, 3, 4, or 5 as allowed by valency;
o is independently at each occurrence an integer selected from 0, 1, 2, and 3;
p is independently at each occurrence an integer selected from 1, 2, 3, and 4;
q is independently at each occurrence an integer selected from 0, 1, 2, and 3;
wherein p+q is equal to or less than 4:
X is independently at each occurrence an anion:
R^{W} is independently selected at each occurrence from alkyl, haloalkyl, alkoxy, alkenyl, alkynyl, aryl, heteroaryl, cycloalkyl, heterocycle, aldehyde, amino, carboxylic acid, ester, ether, halo, hydroxy, keto, nitro, cyano, azido, oxo, silyl, sulfo-oxo, sulfonyl, sulfone, sulfoxide, sulfonylamino, and thiol:
R^{x} and R^{y} independently selected at each occurrence from hydrogen, halo, cyano, nitro, thiol, hydroxy, amino, azido, C₁-C₆ alkyl, C₁-C₆ haloalkyl, and C₁-C₆ alkoxy:
R^{z} is independently selected at each occurrence from hydrogen, C₁-C₆ alkyl, C₂-C₆ alkenyl, C₂-C₆ alkynyl, (C₃-C₆ cycloalkyl)(C₀-C₃ alkyl)—, (3— to 8-membered monocyclic or bicyclic heterocycle)-(C₀-C₃ alkyl)—, (6—to 10-membered monocyclic or bicyclic aryl)-(C₀-C₃ alkyl)—, and (5— to 10-membered monocyclic or bicyclic heteroaryl)-(C₀-C₃ alkyl)—, R^{a}O—(C₁-C₃ alkyl)—, R^{a}S—(C₁-C₃ alkyl)—, (R^{a}R^{b}N)—(C₁-C₃ alkyl)—, R^{a}O—C(O)—(C₀-C₃ alkyl)—, (R^{a}R^{b}N)—C(O)—(C₀-C₃ alkyl)—, R^{c}C(O)—O—(C₁-C₃ alkyl)—, R^{c}C(O)—(R^{a}N)—(C₁-C₃ alkyl)—, RCS(O)₂—O—(C₁-C₃ alkyl)—, RCS(O)₂—(R^{a}N)—(C₁-C₃ alkyl)—, R^{c}C(O)—(C₀-C₆ alkyl)—, and RCS(O)₂—(C₀-C₃ alkyl)—, each of which may be optionally substituted with one or more Y groups as allowed by valency:
R^{a} and R^{b} are independently selected at each occurrence from hydrogen, C₁-C₆alkyl, C₁-C₆haloalkyl, C₂-C₆alkenyl, C₂-C₆alkynyl, (C₃-C_{7cycloalkyl})-(C₀-C₃ alkyl)—, (4— to 6—membered heterocycle)-(C₀-C₃ alkyl)—, (5— to 10-membered monocyclic or bicyclic aryl)-(C₀-C₃ alkyl)—, (5— to 10-membered monocyclic or bicyclic heteroaryl)-(C₀-C₃ alkyl)—, each of which may be optionally substituted with one or more Y groups as allowed by valency:
R^{c} is independently selected at each occurrence from hydrogen, halo, C₁-C₆alkyl, C₁-C₆haloalkyl, C₂-C₆alkenyl, C₂-C₆alkynyl, (C₃-C_{7cycloalkyl})-(C₀-C₃ alkyl)—, (4— to 6—membered heterocycle)-(C₀-C₃ alkyl)—, (5— to 10-membered monocyclic or bicyclic aryl)-(C₀-C₃ alkyl)—, (5— to 10-membered monocyclic or bicyclic heteroaryl)-(C₀-C₃ alkyl)—,—OR^{x}, —SR^{x}, and —NR″R^{y}, each of which may be optionally substituted with one or more Y groups as allowed by valency; and
Y is independently selected at each occurrence from alkyl, haloalkyl, alkoxy, alkenyl, alkynyl, aryl, heteroaryl, cycloalkyl, heterocycle, aldehyde, amino, carboxylic acid, ester, ether, halo, hydroxy, keto, nitro, cyano, azido, oxo, silyl, sulfo-oxo, sulfonyl, sulfone, sulfoxide, sulfonylamino, or thiol.

2. The star polymer of claim 1, wherein n is 3, and
A¹ is 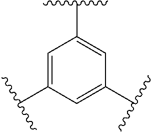
wherein [symbol] is the point of attachment to each of —L¹—A²—(A³)ₘ—A⁴.

3. The star polymer of claim 1, wherein n is 4, and
A¹ is 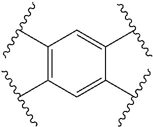
wherein [symbol] is the point of attachment to each of —L¹—A²—(A³)ₘ—A⁴.

4. The star polymer of claim 1, wherein n is 6, and
A¹ is 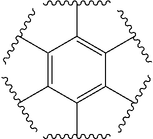
wherein [symbol] is the point of attachment to each of —L¹—A²—(A³)ₘ—A⁴.

5. The star polymer of claim 1, wherein L⁴ is C₁-C₁₂ alkyl or (C₁-C₆ alkyl)(phenylene)(C₁-C₆ alkyl).

6. The star polymer of claim 5, wherein L⁴ is hexyl or

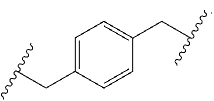 [SMILES: *Cc1ccc(C*)cc1]

7. The star polymer of claim 1, wherein A¹⁰ and A¹¹ are each

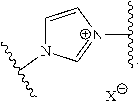

8. The star polymer of claim 1, wherein each n′ is 2, and
each A^{1′} is 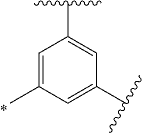 [SMILES: *c1cc(*)cc(C)c1]
wherein * is the point of attachment to L³ and [symbol] is the point of attachment to each of —L¹—A²—(A³)ₘ—A⁴.

9. The star polymer of claim 1, wherein each n′ is 3, and
each A^{1′} is 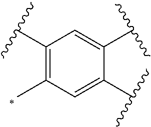 [SMILES: *c1cc(*)c(C)cc1*]
wherein * is the point of attachment to L³ and [symbol] is the point of attachment to each of —L¹—A²—(A³)ₘ—A⁴.

10. The star polymer of claim 1, wherein each n′ is 5, and
each A^{1′} is 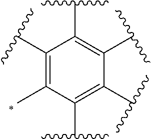 [SMILES: *c1c(*)c(*)c(C)c(*)c1*]
wherein * is the point of attachment to L³ and [symbol] is the point of attachment to each of —L¹—A²—(A³)ₘ—A⁴.

11. The star polymer of claim 1, wherein L¹ is a bond.

12. The star polymer of claim 1, wherein L¹ is —A⁵—A⁶—.

13. The star polymer of claim 12, wherein A⁵ is —C(═O)NH—.

14. The star polymer of claim 12, wherein A⁶ is phenyl optionally substituted with one or more groups selected from R^{x}.

15. The star polymer of claim 12, wherein L¹ is

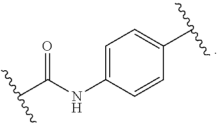 [SMILES: *C(=O)Nc1ccc(*)cc1]

16. The star polymer of claim 1, wherein A² is

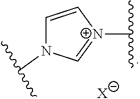

17. The star polymer of claim 1, wherein m is 4, 5, 6, 7, 8, 9, 10, 11, 12, 15, 20, 25, 30, 35, 40, 45, 50, 55, 60, 65, 70, 75, or 80.

18. The star polymer of claim 1, wherein L² is C₁-C₁₂ alkyl.

19. The star polymer of claim 18, wherein L² is hexyl.

20. The star polymer of claim 1, wherein A⁷ is

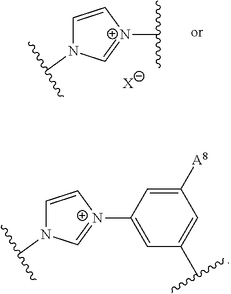

21. The star polymer of claim 1, wherein A′ is R^{w},

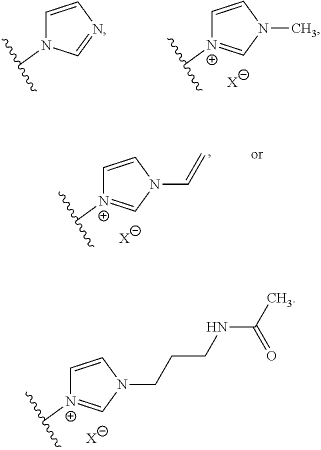

22. The star polymer of claim 1, wherein each X is independently selected from the group consisting of a halide, a carboxylate, a sulfonate, a sulfonimide, a borate, or hexafluorophosphate.
